(19) United States
(12) Patent Application Publication
(10) Pub. No.: US 2007/0233399 A1
(43) Pub. Date: Oct. 4, 2007

(54) METHOD FOR ACQUIRING REACTION DATA FROM PROBE-FIXED CARRIER

(75) Inventor: KEIKO YONEZAWA, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/608,607

(22) Filed: Dec. 8, 2006

(30) Foreign Application Priority Data
Dec. 9, 2005 (JP) 2005-356040(PAT.)
Dec. 8, 2006 (JP) 2006-331380(PAT.)

(51) Int. Cl. G06F 19/00

(52) U.S. Cl. 702/20

(57) ABSTRACT

Reaction data are obtained from a reaction between a testing sample and a probe carrier on which a plurality of blocks containing a number of probes are arranged. Initially, a signal is detected from the probe carrier having reacted with the testing sample. Then, a data sequence is prepared based on the detected signal. Subsequently, the data sequence is subjected to frequency transformation to obtain frequency-transformed data. Then, filtering is performed on the frequency-transformed data to leave a frequency component corresponding to a repetition of the blocks. Finally, the filtered data is subjected to inverse frequency transformation to thereby acquire reaction data.

### BACKGROUND OF THE INVENTION

1. Field of the Invention

The present invention relates to a method for acquiring reaction data from a reaction, between a probe and a biosubstance in a testing sample, occurring on a probe-fixed carrier which fixes a large number of probes such as nucleic acid or peptide fragments for inspecting a sample onto a solid carrier to detect the biosubstance in the testing sample, or occurring on a carrier which fixes a target substance in a testing sample thereon.

2. Description of the Related Art

Microarrays are known as a typical probe-fixed carrier which fixes a large number of probes that can bind specifically to a detection target substance, on a solid phase carrier in a predetermined arrangement. Such a microarray is prepared by fixing a large number of micro-spots of probes densely on a two-dimensional plane of the solid phase carrier. By reacting a testing sample with the microarray and identifying the reacted and unreacted probes based on the positions of fixing the probes, the substance present in the testing sample can be detected and the structure of the substance can be determined based on the kinds of the reacted probes. That is, the use of a microarray makes it possible to simultaneously execute a plurality of reactions on a small volume of a testing sample and to collect the results of individual reactions on the basis of the address information of the probe-fixing positions.

The results of individual reactions are detected by a radio-isotope (RI), a fluorescent label and the like so as to allow observation even on a small quantity of the reaction product. In recent years, however, the use of a RI is somehow restricted because of the strict control on handling of a RI and some other reasons.

Fluorescence labeling allows reading of the reaction result by a scanner and the like and provides image data including positional information. By analyzing the image data, a certain result of judgment can be obtained.

In the case where the positions of individual probes fixed on a microarray are identified by address information, the resulting image data will show a regular pattern. Known regular patterns include, for example, a tile pattern observed in GeneChip of Affymetrix Inc., and a grid pattern of spots observed on a microarray prepared by spotting.

When each probe or spot fixed on a microarray is tagged for identification, each probe is identified by the tag, the fixing positions of probes are not necessarily regular but may be random. However, they are usually fixed in a regular pattern to some degree. An example of utilizing such tags is the GoldenGate Assay method of Illumina Inc., as seen in U.S. Pat. No. 6,355,431.

There are a variety of methods for analyzing image data utilizing a certain regularity in image data and thereby correcting the analyzed image data, i.e., for processing image data. A method of applying an image data analysis technology to the inspection of defects is known as a surface inspection method for detecting defects in a regular pattern of a semiconductor wafer, as seen in Japanese Patent Application Laid-open No. H08-045999. As an application of image data analysis to microarrays, ArrayPro of Media Cybernetics Inc., is known, as seen in U.S. Pat. No. 6,498,863.

ArrayPro is a software which utilizes a fluorescence image obtained from a microarray having a regular grid arrangement of high intensity spot portions or square tiles, to thereby automatically extract information of domains where bio-samples exist in the image. Many of the known spot-extracting softwares are to overlay a preliminarily prepared grid pattern visually on the image. However, ArrayPro allows automatic spot extraction and has significantly contributed to realizing a high throughput microarray analysis.

While spot extraction has become available by utilizing a regularity of image data as mentioned above, there is a further need of giving a meaningful judgment on the extracted data.

A variety of applications of a microarray have been developed. In the case of, for example, a DNA (or RNA) microarray which fixes nucleic acid fragments thereon, hybridization and/or extension reaction may be performed in the course of the overall reaction. As an example of using proteins as a probe, there is known a method of determining a detection target substance by an antigen-antibody reaction. If such a biochemical reaction is conducted on a solid phase with a small amount of testing sample, irregularities of reaction or defects of probe-fixing portion may possibly affect on the result of determination.

In particular, when temperature control is necessarily conducted, a temperature rise can induce foaming in some cases, which definitely affects on the result as irregularities of reaction. Typical examples of such phenomenon include the case that the temperature is raised to 90° C. or above during hybridization reaction for denaturing of the target.

Correction of such data dispersion and conduction of data processing to derive a correct judgment will therefore become critical technologies for actual application of a microarray.

Inspection of a testing sample using a microarray utilizes a specific binding between two complementary strands of DNA or RNA, or a biological reaction such as an antigen-antibody reaction. As a result, there often occurs “dispersion” in a result of inspection. The most simple method for decreasing such “dispersion” is to obtain two or more of inspection results under the same conditions, and to determine the average of them as a typical representative. In a conventional method for deriving an average value, one and the same probes are fixed on a microarray, and an average value is derived from the obtained results.

FIG. 2 shows an example of microarray. The microarray shown in FIG. 2 comprises a substrate on which nine blocks having one and the same constitution, each block containing 16×16 spots, are fixed (see the enlarged view). To the corresponding spots of the nine blocks, the same probe is fixed. When a substance in the testing sample, for example the substance to be detected (target substance), binds to a probe on the substrate, the state of binding is detected utilizing the emission of light, for example the emission of fluorescence. Most simply, where a microarray having the structure of FIG. 2 is designed, a more precise value for the testing sample is obtained through determination of an average value or a variance of the luminous intensities of the same nine probe spots at the corresponding positions of the respective blocks. Also it is possible to determine the degree of dispersion of values for the testing sample. By comparing the value of variance (or standard deviation) with the luminous intensities of other testing sample spots, it can be discussed about the possibility of comparing them, or about the significant difference in the luminous intensities between testing samples.

However, the reaction between a probe fixed on the substrate and a target substance contained in the liquid testing sample does not necessarily occur homogeneously as generally observed in liquid phase reactions, and the problems of irregularities of reaction or defects at the time of fixation may affect the intensity on the substrate. An example of such problems is the occurrence of irregularities of reaction when the probe nucleic acid captures the target nucleic acid on the fabricated microarray. That is, to conduct the hybridization of the target nucleic acid and the probe nucleic acid, the step of increasing and decreasing the temperature is carried out, which can cause foaming to occur in the liquid testing sample on the microarray, which in turn cause irregularities of reaction to occur at the portion of foaming on the substrate. This phenomenon often appears during a temperature rise to about 90° C. in the process called “denaturing” which is conducted to preventing a long strand target nucleic acid from forming a self-binding (double-stranded) structure. If the amount of a testing sample is small, the influence of foaming on the total analysis result is more serious.

If such irregularities of reaction occurred, adoption of a simple average of nine data as described above may lead to over-emphasizing of the irregularity of a single data to give a value with large deviation from the other eight data. To prevent such a false result, a median value, not an average value, is adopted as an estimate for the real value in some cases.

The above-described method cannot be said as effectively using the periodicity of nine blocks, or using the fact that the spots at the corresponding positions of the respective blocks indicate the reaction with the same testing sample. Consequently, the above-described method cannot be said as an efficient data analysis method for a microarray on which a plurality of probes are fixed regularly on a substrate.

### SUMMARY OF THE INVENTION

According to the present invention, there is provided a method for acquiring reaction data from a reaction between a testing sample and a probe carrier on which a plurality of blocks containing a number of probes are arranged, comprising the steps of: detecting a signal from the probe carrier having reacted with the testing sample; preparing a data sequence based on the detected signal; subjecting the data sequence to frequency transformation to obtain frequency-transformed data; performing filtering on the frequency-transformed data to leave a frequency component corresponding to a repetition of the blocks; and subjecting the filtered data to inverse frequency transformation to acquire reaction data.

Further features of the present invention will become apparent from the following description of exemplary embodiments with reference to the attached drawings.

### BRIEF DESCRIPTION OF THE DRAWINGS

FIG. 1 shows a total flow diagram of the data processing according to the present invention.

FIG. 2 illustrates an exemplary arrangement of DNA probes on a microarray.

FIG. 3 schematically illustrates an example of one-dimensionalization.

FIG. 4 illustrates an exemplary arrangement of marker probes.

FIG. 5 illustrates another exemplary arrangement of marker probes.

FIG. 6 shows the conditions of temperature cycle of PCR.

### DESCRIPTION OF THE EMBODIMENTS

The method for acquiring reaction data according to the present invention is suitably applicable to an inspection device (probe-fixed carrier) such as a microarray on which a plurality of domains (blocks) having the same constitution (i.e., having the same arrangement of probes) as each other, are fixed in a repetitive pattern.

According to the method for acquiring reaction data of the present invention, ineffective results due to e.g. irregularities of reaction are removed utilizing a periodicity that is observed in signals as a data sequence which are collected from individual probe-fixed domains (i.e. containing spots).

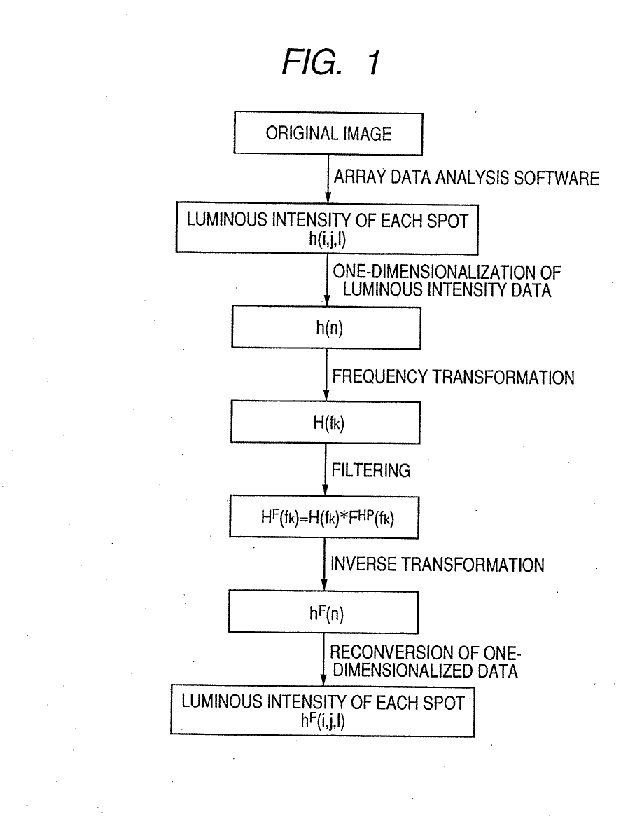

FIG. 1 shows an example of flow diagram of steps in an example of the method for acquiring reaction data according to the present invention. Signals obtained from each probe spot on an inspection device as a probe-fixed carrier are inputted into a computer using an array data analysis software, and the signals are stored at an adequate address, as needed. The signals may be those of fluorescence intensity of a fluorescent label incorporated in the course of formation of a combined body resulting from a reaction between a probe and a substance in a testing sample (e.g., a target substance). The signals are not limited to fluorescence, and any kind of signals are applicable if only they are collected as data. In FIG. 1, fluorescence intensity data are used as signals.

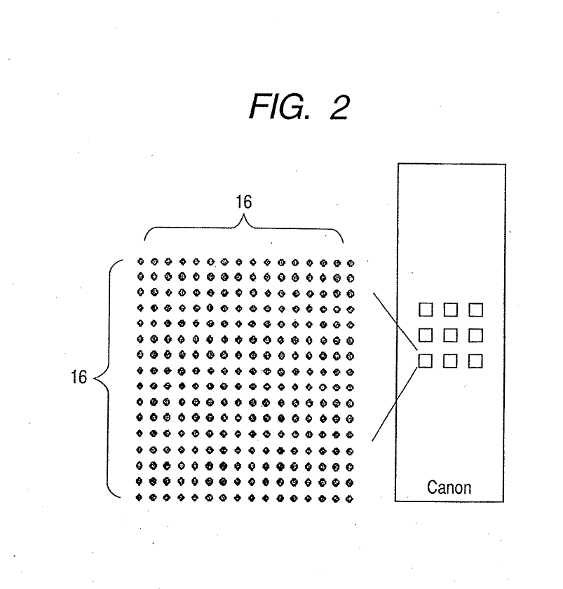

Examples of the structure of an inspection device are illustrated in FIGS. 2, 4 and 5. Nine blocks in FIG. 2 have the same arrangement of 16×16 probe spots, respectively. That is, the arrangement of 16×16 probe spots is repeated nine times on the substrate. The probes to be arranged on each block are selected as desired for analyzing the substance in the testing sample. For example, one can select probes which are necessary for detection of target genes, identification of species and genus of microorganisms, detection of a substance functioning as a disease marker and the like and selected probes are positioned in a block in a specific arrangement effective for the detection.

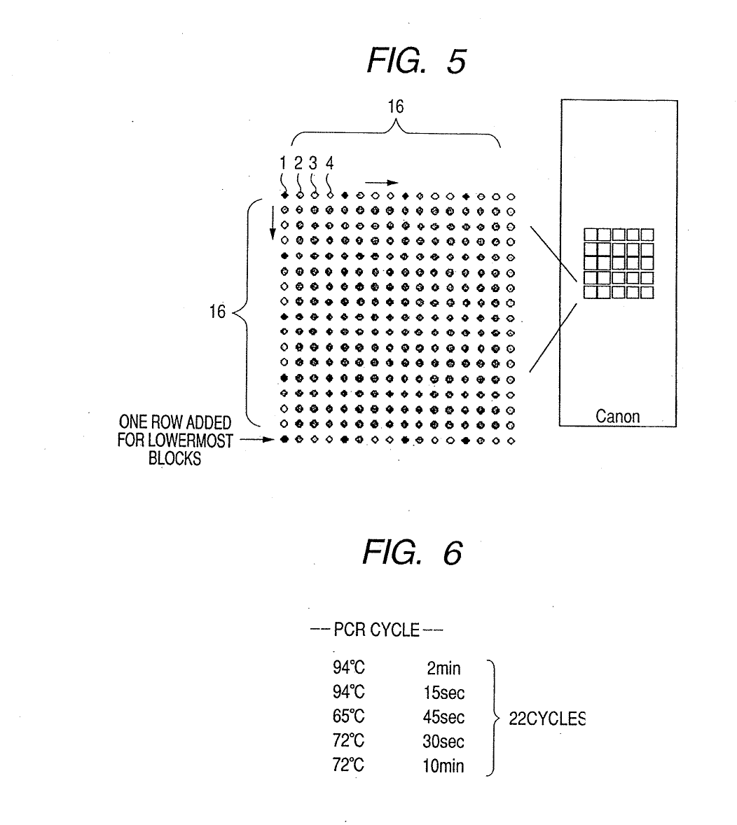

According to the first embodiment of the data processing of the present invention, fluorescence intensities are collected from the entire probe spots in the plurality of repetitive domains (blocks) having the same probe array sequence as each other. For example, the fluorescence intensities of all the probe spots in the microarray given in FIG. 2 are collected. According to the second embodiment of the present invention, the fluorescence intensities of all the marker probe spots in the plurality of repetitive blocks are collected for the purpose of data processing. For example, the fluorescence intensities of all the marker probe spots given in FIGS. 4 or 5 are collected.

The marker probes are selected such that they do not have any interaction with the substances in the testing sample. If the probe and the target substance are nucleic acid, they are preferably used after applying the homology search or the like to confirm that the sequence of the marker probe does not induce hybridization with the sequence in the specimen as the testing sample. Furthermore, it is more preferable that the marker probe is selected after confirming that the signals from the marker probe are not observed when marker probes are hybridized with the labeled target nucleic acid under the conditions that the fluorescence-labeled marker probe complementary strand as the control is not included.

The fluorescence intensities inputted into the computer are one-dimensionalized and then subjected to frequency transformation. The frequency transformation may preferably be Fourier transformation. Then, the frequency-transformed data are treated by filtering, thereby leaving a frequency component corresponding to the repetitive blocks having specific arrangement of probes or marker probes from all the frequency components. Subsequently, the filtered (remaining) frequency components are inversely transformed, followed by reconversion of the one-dimensionalized data, to thereby obtain each intensity of the spots.

The method in accordance with the above flow diagram according to the present invention is suitably applicable to the analysis of a large volume of data acquired from a high throughput device such as a microarray.

The microarrays shown in FIGS. 2, 4, and 5 are examples of DNA microarray which fix probes of DNA onto a substrate as a carrier using the ink-jet method (refer to Japanese Patent Application Laid-open No. H11-187900). The combination of the probe and the substance to be detected by the probe is not limited to the combination of a DNA probe and a target DNA. For example, the probe may be selected, depending on the detection target substance, from nucleic acids and modified nucleic acids such as RNA and PNA, proteins, sugar chains and the like.

The above first embodiment of the present invention is described using an example of probe-fixed carrier, or a carrier on which the probe is fixed. The present invention, however, is not limited to the example, and is applicable in similar manner for the case that a target substance-fixed carrier, or a carrier on which the target substance as the detection target is fixed, is adopted, and that the reaction data acquired from the reaction with probe is adopted.

The present invention is described in more detail below referring to the examples.

(Structure of Microarray)

FIG. 2 shows a microarray structured by a substrate and probes fixed thereon. As detailed in Japanese Patent Application Laid-open No. H11-187900, the fixation of probes is done by the ink-jet method that ejects oligo DNA, which has a base-sequence as a probe and has a thiolated 5′ terminal, onto a surface-treated substrate. The DNA as a probe has a length of about 25 bases, purchased from BEX Co., Ltd.

(Blocking)

Before conducting a hybridization reaction, a blocking reaction is conducted. The blocking of a microarray is done to prevent the adsorption of nucleic acid molecules to the portions other than the probe portions on the microarray. The blocking reaction is usually conducted immediately before the hybridization reaction. The blocking is effected by the steps of dissolving BSA (bovine serum albumin, Fraction V, manufactured by Sigma, Inc.) in a 100 mM NaCl/10 mM phosphate buffer solution to a concentration of 1% by weight, and of immersing the DNA microarray in the solution at room temperature for 2 hours. After the completion of blocking, the product is washed by a 0.1×SSC solution (trisodium citrate and NaCl) containing 0.1% by weight of SDS (sodium dodecyl sulfate), and by an SSC solution containing no SDS, successively. After that, the product is rinsed by ultrapure water and is then dewatered by spin-drying.

(Preparation of Target)

Amplification (PCR) reaction and labeling reaction of specimen-originated nucleic acid are exemplified below. Typical compositions of amplification and labeling reaction liquids are given below.

Composition of PCR solution
Premix PCR reagent (TAKARA ExTaq): 25 μl
Template Genome DNA: ˜5 ng
Forward/Reverse Primer: 0.05 μM each
(Total: 50 μl)

A reaction liquid having the above composition is subjected to amplification reaction using a thermal cycler following the protocol of temperature cycle given in FIG. 6. For labeling the target, the reaction is conducted using a Cy3-labeled primer. After completing the reaction, the unreacted primer is removed using a purification column (QIAGEN QIAquick PCR Purification Kit, by QIAGEN Inc.) Then, the amplified product is determined by electrophoresis (using Bioanalyzer made by Agilent Inc.)

(Hybridization)

A dewatered DNA microarray is mounted on a hybridization apparatus (Hybridization Station, made by Genomic Solutions Inc.) to conduct a hybridization reaction with the hybridization solution and under the conditions given below. Alternatively, the reaction may be conducted manually using a slide glass and a chamber for hybridization instead of such a hybridization apparatus.

(Hybridization Solution)

A typical composition of hybridization solution is given below.

6×SSPE/10% Formamide/Target (nucleic acid originated from unknown specimen) (500 ng of PCR product)/Labeled control probe complementary strand (ultimate concentration: 1 nM)

About 500 ng of amplified nucleic acid originated from the unknown specimen is dissolved in a buffer solution (SSPE). Formamide is added to the solution to an ultimate concentration of 10%. Then the labeled probe complementary strand is added to the solution to an ultimate concentration of 1 nM, thus preparing a hybridization solution. The concentration of buffer solution (SSPE) is preliminarily calculated to 6×SSPE in the ultimate state.

Thus prepared hybridization solution is heated to 65° C. and held at the temperature for 3 minutes. The solution is then held at 92° C. for 2 minutes, and further at 45° C. for 3 hours. After that, the solution is rinsed by 2×SSC and by 0.1% SDS at 25° C., successively. The solution is further rinsed by 2×SSC at 20° C., and, as needed, is rinsed by pure water in accordance with an ordinary procedure, to remove the unreacted target originated from the unknown specimen, and the labeled probe complementary strain, followed by dewatering by a spin-dry apparatus.

(Fluorescence Measurement)

The fluorescence measurement is conducted for the DNA microarray after completion of the hybridization reaction using a fluorescence detector for DNA microarray (GenePix 4000B, made by Axon Inc.) by adjusting the measurement wavelength to the wavelength of fluorescence of the fluorescent substance of the target label and the labeled probe complementary strand and controlling the intensity of exciting light so that the measured fluorescence intensity will be 30000 or smaller.

(Spot Analysis)

The resulting image of the fluorescence measurement is analyzed by the data analysis software for microarray (ArrayPro, by Media Cybernetics Inc.) to obtain luminous intensity data for the coordinates (i, j, l) of each spot where i is the row number in the block (0 to 15), j is the column number in the block (0 to 15), and l is the block number (0 to 8). The obtained data are further processed to obtain the reaction data as described below.

### EXAMPLE 1

A nucleic acid microarray used in this example comprises 3×3=9 blocks which are one and the same others and are each constituted of 16×16 spots as shown in FIG. 2. Different oligo DNA fragments are fixed to the respective spots of each block. Hybridization reaction to the microarray is conducted with Cy3-labeled target DNA of about 500 bp. After that, the fluorescence intensity of the microarray is measured by a scanner to obtain an image of fluorescence intensity. The obtained image is analyzed by a commercially available software for array analysis, thus obtaining the luminous intensity of each spot. The steps of preparing the target, conducting the hybridization reaction, measuring the luminous intensity, and analyzing the image are carried out as described above.

The result of intensity analysis by the image analysis software is outputted so that the intensity of spot (i,j) in block 1 is expressed as h(i,j,l). When the value of n=N_{COL}*i+j+N_{SPOT*1 is expressed as h(n)=h(i,j,l), the intensity data on a chip is expressed by a one-dimensional data sequence. The symbol N}_{COL} represents the number of columns in a block (16 in FIG. 2), and N_{SPOT} represents the total number of spots in a block (16×16=256 in FIG. 2.) The total number of spots on a single substrate is represented by N=N_{SPOT}*N_{BLOCK}, and the symbol N_{BLOCK} represents the number of blocks on a substrate (9 in FIG. 2.)

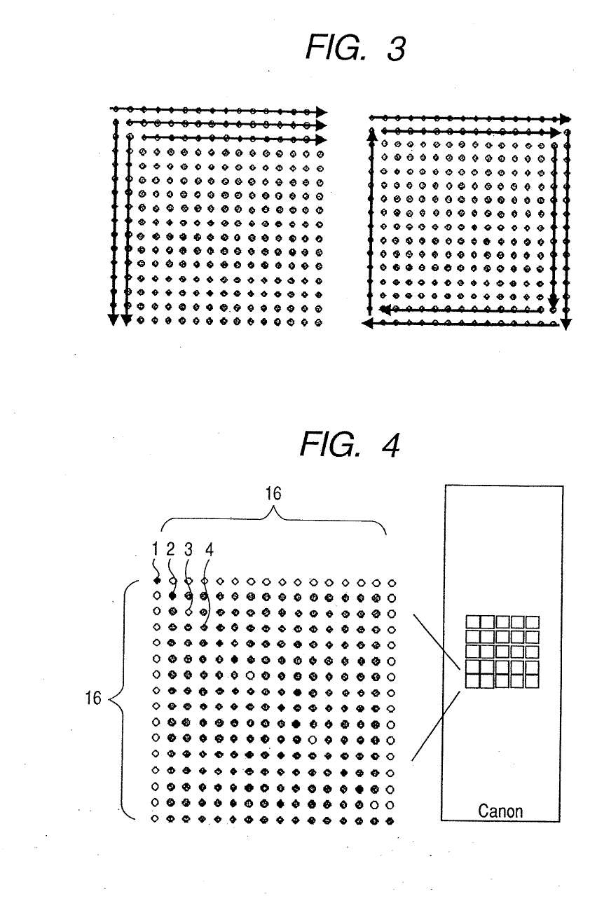

While in this example, a one-dimensional data sequence is obtained in a most simple manner, a plurality of methods are available for one-dimensionalization. For example, the order of counting may be varied between blocks as seen in FIG. 3, or alternatively, three blocks adjacent to one another may be regarded as one integrated block to count the spots along the hypothetical rows or columns of the integrated block, though the latter method cannot utilize the periodicity of the blocks as it is. Accordingly, the one-dimensionalization can be performed by numerous methods, and a suitable one can be selected depending on the object (i.e., what kind of ineffective result should be removed).

The h(n) is subjected to Fourier transformation as given below.

$$H ( {f}_{k} ) = \frac{1}{N} {\sum }_{n = 0}^{N - 1} h ( n ) exp ( - \frac{2 π nk}{N} ⅈ )$$

$${f}_{k} = \frac{k}{N}$$

where k is integer from 0 to N−1.

Since the substrate has a plurality of identical blocks, as shown in FIG. 2, a periodicity of

$${f}_{{N}_{BLOCK}} = \frac{{N}_{BLOCK}}{N}$$

exists. In addition, depending on the probe arrangement in the block, there may exist a component of higher frequency fₘ (m>N_{BLOCK}). For example, a block contains different kinds of probes respectively arranged with a periodicity.

On the other hand, there may exist a periodicity of

$${f}_{1} = \frac{1}{N}$$

Although this periodicity is a frequency component which does not appear if the hybridization reaction proceeds under an ideal state, the component appears when the influence of irregularities of reaction or defects on the substrate is reflected. Since that type of frequency component hinders the accurate calculation of luminous intensity, it should be filtered out.

To do this, for example, by preparing a function

$${F}_{\frac{{N}_{BLOCK}}{N}}^{HIghPass} ( {f}_{k} )$$

that has a high-pass filter characteristic having a cutoff frequency of

$${f}_{{N}_{BLOCK}} = \frac{{N}_{BLOCK}}{N}$$

is considered and a filtering function H^{F}(fₖ) is derived.
H^{F}(fₖ)=H(fₖ)*F_{N}_{_{BLOCK/N}}^{HighPass}(fₖ)
By applying inverse Fourier transformation to this function,

$${h}^{F} ( n ) = {\sum }_{k = 0}^{N - 1} {H}^{F} ( {f}_{k} ) exp ( \frac{2 πkn}{N} ⅈ )$$

such defects as those due to irregularities of reaction are efficiently rejected.

A variety of filters can be used for the above purpose. That is, a high-pass filter having a different threshold value may be adopted, or a filter leaving only the proximity of

$${f}_{{N}_{BLOCK}} = \frac{{N}_{BLOCK}}{N}$$

(provided that any high frequency components reflecting the probe arrangement are not cut out) may be adopted.

In respect of the profile of window, a variety of window functions which are generally used to cut signals can be used.

### EXAMPLE 2

Different from Example 1, the microarray of Example 2 shown in FIG. 4 has 25 blocks on a substrate. In each block, the spots which are not the marker probes (the marker probes are arranged on the right-down diagonal of each block and all the other probes are probes used for detecting a testing sample) are different, and hence the microarray of FIG. 4 fixes 6000 probes different from one another. In FIG. 4, the marker probes No. 1 to No. 4 are arranged repetitively in this order on the diagonal.

According to the example of FIG. 4, four kinds of marker probes are arranged on the diagonal of the matrix of 16×16 probes in each block. However, the number and the arrangement of different marker probes are arbitrary. While a larger number of marker probes are more favorable for filtering, then the number of probes arrangeable for detecting specimen decreases. Therefore, it is necessary to select the kind and the arrangement of probes taking into account the necessary level of filtering. For example, in the case where marker probes are arranged only on an edge of the block, the defects such as irregularities of reaction occurring only inside the block may not be able to handle. If, however, the diagonal arrangement of marker probes as in Example 2 is adopted, it is expected that some marker probes overlap the position of irregularities of reaction or the defective portions in the block, which is favorable for filtering.

With a substrate having the structure of FIG. 4, the hybridization reaction is conducted similar to Example 1. The steps from the preparation of a testing sample to the fluorescence detection and spot intensity analysis are the same as in Example 1.

As in Example 1, there are a variety of applicable methods for one-dimensionalization. A large difference is, however, the use of only the values for marker probes. For the marker probes arranged as in FIG. 4, if the luminous intensity of each spot (i,j,l) is expressed by h(i,j,l), one-dimensionalization is performed as h(n=i+N_{COL}*l)=s(i,i,j). This is because the combination of coordinates (i,j,l) is limited to i=j=0 to N_{COL}−1 and l=0 to N_{BLOCK}−1. In this case, the number of rows and the number of columns of block are the same (N_{ROW}=N_{COL}). As the preparation for frequency analysis, a one-dimensional sequence is prepared, as in Example 1, by expressing the total number of marker spots on a single substrate as N (N=N_{BLOCK}*N_{COL}), which sequence is then expressed as h(n).

To the one-dimensionalized luminous intensity data of marker probes, h(n), Fourier transformation was applied as in Example 1. While there may be a variety of applicable filtering methods, filtering is performed to remove the components of lower frequency than the frequency of

$${f}_{{N}_{BLOCK}} = \frac{{N}_{BLOCK}}{N}$$

considering that the primary object is to remove defects on substrate and irregularities of reaction.

$${H}^{F} ( {f}_{k} ) = H ( {f}_{k} ) * {F}_{\frac{{N}_{BLOCK}}{N}}^{HighPass} ( {f}_{k} )$$

After that, similar to Example 1, inverse Fourier transformation is applied to determine the h^{F}(n) of marker probes.

It should be noted that, different from the case of Example 1, the simple determination of h^{F}(n) is not the end because the data processing of only marker probes has no significance. In this example, correction of intensities within the same block is performed utilizing the h^{F}(n).

While there are a variety of correction methods, this example adopts, most simply, the correction term A(i,i,l) of each block as

$$A ( i , i \cdot l ) = \frac{{h}^{F} ( i , l )}{h ( i , l )}$$

where, h(i,l)=h(n=i+N_{COL}*1). The correction to the probes other than marker probes was done by
s_{New}(i,j,l)=s(i,j,l)*[A(i,l)+A(j,l)]/2

That kind of correction is particularly effective to the spots in the vicinity of the center of a block, (in the vicinity of marker probes), as seen in the marker probe arrangement in FIG. 4.

### EXAMPLE 3

In addition to the correction of spots in the vicinity of the center of a block (in the vicinity of marker probes) in Example 2, a marker probe arrangement shown in FIG. 5 is designed as the marker probe arrangement effective for all area of the block. Usually, marker probes are positioned at the uppermost row and the leftmost column in each block (marker probes No. 1 to No. 4 are repetitively arranged in this order). To the blocks at the rightmost column and at the lowermost row, however, a single line of marker probes is added outside the normal block. As a result, each block has 225 different probes, while those probes are surrounded by marker probes on the left, right, top and bottom thereof.

Also in this example, as in Examples 1 and 2, Fourier transformation is applied after one-dimensionalization. Filtering is performed as

$${H}^{F} ( {f}_{k} ) = H ( {f}_{k} ) * {F}_{\frac{{N}_{BLOCK}}{N}}^{HighPass} ( {f}_{k} )$$

as in Examples 1 and 2.

Using the obtained h^{F}(n), the following correction is performed to the individual marker probes as in Example 2 as

$$A ( i , j , l ) = \frac{{h}^{F} ( i , j , l )}{h ( i , j , l )}$$

where (i,j,l) is the position of marker probe, and n is the corresponding value of the marker probe given at the one-dimensionalization performed prior to Fourier transformation. The correction to the probes other than the marker probes, using the above values is performed as

$$\begin{matrix}{s}_{New} ( i , j , l ) = \frac{1}{2} s ( i , j , l ) ( \frac{( ( i - {i}_{l} ) {A}^{M} ( {i}_{r} , j , l ) + ( {i}_{r} - i ) {A}^{M} ( {i}_{l} , j , l ) )}{{N}_{COL} - 1} + \\ \frac{( ( {j}_{u } - j ) {A}^{M} ( i , {j}_{d} , l ) + ( j - {j}_{d} ) {A}^{M} ( i , {j}_{u} , l ) )}{{N}_{ROW} - 1} )\end{matrix}$$

where, i₁ and iᵣ correspond to the markers nearest on the left side and nearest on the right side, respectively, in the same row as that of the spot concerned, and jᵤ and j_{d} correspond to the markers nearest on the upper side and nearest on the lower side, respectively, in the same column.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2005-356040, filed Dec. 9, 2005 and No. 2006-331380, filed Dec. 8, 2006, which are hereby incorporated by reference herein in their entirety.

What is claimed is:

1. A method for acquiring reaction data from a reaction between a testing sample and a probe carrier on which a plurality of blocks containing a number of probes are arranged, comprising the steps of:
detecting a signal from the probe carrier having reacted with the testing sample;
preparing a data sequence based on the detected signal;
subjecting the data sequence to frequency transformation to obtain frequency-transformed data;
performing filtering on the frequency-transformed data to leave a frequency component corresponding to a repetition of the blocks; and
subjecting the filtered data to inverse frequency transformation to thereby acquire reaction data.

2. A method for acquiring reaction data according to claim 1, wherein said frequency transformation is Fourier transformation.

3. A method for acquiring reaction data according to claim 1, wherein said filtering has a high-pass filter characteristic of which cutoff frequency is a frequency corresponding to the repetition of the blocks.

4. A method for acquiring reaction data according to claim 1, wherein said data sequence is prepared by forming a one-dimensional data sequence for each block based on the detected signal and then forming a combined data sequence of the one-dimensional data sequence of each block.

5. A method for acquiring reaction data according to claim 1, wherein said filtering is performed by cutting out a lower frequency component having a lower frequency than a frequency component corresponding to a frequency determined on the basis that the total number of probes in a single block is counted as a single cycle.

6. A method for acquiring reaction data according to claim 1, wherein said block contains probes which can react with a target substance in the testing sample and marker probes.

7. A method for acquiring reaction data according to claim 6, wherein said step of preparing a data sequence forms a data sequence corresponding to the marker probes based on the detected signal.

8. A method for acquiring reaction data according to claim 7, wherein said filtering has a high-pass filter characteristic of which cutoff frequency is counted on the basis that the number of the marker probes in the block as a single cycle.

9. A method for acquiring reaction data according to claim 7, wherein said filtering is performed by cutting out a lower frequency component having a lower frequency than a frequency component corresponding to a frequency determined on the basis that the total number of the marker probes in a single block is counted as a single cycle.

10. A method for acquiring reaction data according to claim 7, further comprising the step of correcting a signal corresponding to the probes other than the marker probes, based on the reaction data obtained by inverse frequency transformation of the filtered frequency component.

11. A method for acquiring reaction data according to claim 1, wherein said probe is nucleic acid.

12. A method for acquiring reaction data according to claim 1, wherein said probe is peptide nucleic acid.

13. A method for acquiring reaction data according to claim 1, wherein said blocks are arranged in a two-dimensional array at a specified interval.

14. A method for acquiring reaction data according to claim 7, wherein said marker probes are arranged on a diagonal in each block.

15. A method for acquiring reaction data according to claim 7, wherein said marker probes surround each block.

16. A method for acquiring reaction data according to claim 15, wherein said filtering is performed separately on the marker probes arranged in a row and on the marker probes arranged in a column.
